(19) United States
(12) Patent Application Publication
(10) Pub. No.: US 2017/0089717 A1
(43) Pub. Date: Mar. 30, 2017

(54) USE OF ROAD LANE DATA TO IMPROVE TRAFFIC PROBE ACCURACY

(71) Applicant: Garmin Switzerland GmbH, Schaffhausen (CH)

(72) Inventors: Kerry M. White, Lenexa, KS (US); Kyle J. Hill, Lenexa, KS (US)

(21) Appl. No.: 14/868,581

(22) Filed: Sep. 29, 2015

(51) Int. Cl. G01C 21/36; G01C 21/34; G08G 1/0968; G08G 1/01; G08G 1/052

(52) U.S. Cl. CPC G01C 21/3658; G08G 1/0112; G08G 1/0125; G08G 1/052; G08G 1/096827; G01C 21/3492; G01C 21/3694; G01C 21/367

(57) ABSTRACT

A mobile computing device is described that provides navigational guidance with lane-level granularity. The mobile computing device may be configured to measure and transmit its respective traffic data, which may include an indication of a vehicle road lane in which a vehicle is currently travelling, the speed of the vehicle driving in this road lane, and/or an indication of how long it takes for the vehicle to pass through various intersections in various lanes. The traffic data may be transmitted from several mobile computing devices to a traffic aggregation service, which may calculate an average vehicle speed and average intersection timing on a per-road lane basis. The traffic service may broadcast the averaged data to one or more mobile computing devices configured to receive this information. The mobile computing devices may use the averaged data to optimize routing and/or to improve the accuracy in which route driving times are calculated.

### BACKGROUND

Typical traffic service providers use traffic data received from various traffic “probes,” which may be implemented as mobile computing devices, smartphones, etc. Traffic probes may be located in vehicles and collect and transmit information related to current traffic conditions, such as the speed of traffic along certain roadways or the location of an accident, to a traffic service provider. These probes may generate and transmit traffic probe data of varying accuracy or “grades.” For example, the lowest grade probes are typically associated with a triangulated probe positions that are based on proximity to cell towers, which is the least accurate. Some probes may additionally transmit embedded geographic location data (e.g., global positioning system (GPS) data) but not map data, resulting in a more accurate position and a better grade of data than probes using only triangulation. The most accurate and highest grade probe data is generally associated with traffic probes that include a navigation application and/or are implemented as part of a personal mobile computing device (PND), which correct the GPS location to match the present road.

Conventional mobile computing devices may connect to the traffic service provider to collect and display useful traffic information along a driving route, and may provide users with the option to route around delays or to otherwise avoid them. Once a route is chosen by a user, conventional mobile computing devices may calculate an arrival time that the user should reaches his destination using the speed of traffic supplied by the traffic service provider along a current route.

However, the traffic data used by the traffic service provider to calculate the speed of traffic on a particular road has a relatively low resolution due to the way the data is collected. For example, for a given period of time, several hundred vehicles may traverse a portion of a particular roadway travelling in various lanes, which may include on ramps, off ramps, and/or frontage roads, in some cases. Typical traffic probes passing through this portion of the roadway may transmit their current speed, but not other information such as the specific road lane in which they are travelling. Therefore, a particularly slow ramp and/or road lane may induce error when the collected traffic probe speeds are averaged together. Conventional mobile computing devices may also calculate driving routes using the traffic speed data supplied by the traffic service provider. Because this traffic speed data is subject to the aforementioned errors, these driving routes may not be the fastest routes.

Mobile computing devices may also use the inaccurate traffic speed data to calculate the arrival time, which is therefore likewise prone to inaccuracies. To further compound these inaccuracies, when typical mobile computing devices do account for the time it takes to drive through the various intersections along a calculated route, such devices do not typically differentiate between two intersections that look identical from a geometry perspective, but intersections that have differing traversal times based on lane traffic. For example, in right-side driving countries, typical mobile computing devices may cost a left-turn more heavily in terms of time than proceeding straight through the intersection, while a right turn (in right-side driving countries) usually takes less time. However, these devices do not account for lane backups on the lane level, potentially resulting in current traffic providers averaging out such lane backups if the through-lanes are flowing smoothly.

As a result, current driving mobile computing devices have several drawbacks.

### SUMMARY

Embodiments of the present technology relate generally to mobile computing devices used in a vehicle and, more specifically, to mobile computing devices that transmit and receive traffic speed and/or heading data at the road lane level, and use this traffic speed and/or heading data to provide enhanced vehicle navigation.

Embodiments are disclosed describing a mobile computing device. The mobile computing device may be mounted in a vehicle and include one or more sensors and/or cameras positioned to record video in front of the vehicle and to generate and store the video data. The mobile computing device may analyze this video data to determine which of several road lanes the vehicle is currently travelling. This determination may be done with or without the assistance of cartographic data, which may indicate the total number of road lanes for a given road on which the vehicle is currently travelling by referencing the geographic location of the vehicle. The mobile computing device may be one of several mobile computing devices (or other traffic probes) configured to transmit traffic data, such as its current road lane information, an indication of the vehicle's speed while travelling in the current road lane, the geographic location of each device, and/or intersection timing data that indicates an average time for each vehicle to travel through various intersections, to an external computing device.

In another embodiment, the external computing device may identify vehicles travelling in the same road lanes using the road lane information and/or geographic location data transmitted by one or more traffic probes. The external computing device may aggregate data received from several mobile computing devices identified as travelling in the same lane to calculate average road speeds on a per-lane basis. The external computing device may also calculate average intersection times that indicate an average time for several vehicles to travel through various intersections, which may also be calculated on a per-lane basis.

In yet another embodiment, the mobile computing device may receive the average road lane speeds and/or the average intersection times and use this data to calculate navigation routes on a per-road lane basis. The mobile computing device may optimize a route by selecting road lanes having faster average road lane speeds and/or by selecting a route with intersections having faster average intersection times. The mobile computing device may also calculate a driving route time incorporating the average road lane speeds and/or the average intersection times, thereby improving the accuracy of estimated time of arrival (ETA) calculations.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, whenever possible, the following description refers to the reference numerals included in the following figures, in which features depicted in multiple figures are designated with consistent reference numerals.

FIG. 1 is an illustration of a block diagram of an exemplary navigation system 100 in accordance with an embodiment of the present disclosure;

FIGS. 2A-2B are schematic illustration examples of user interface screens 200, according to an embodiment;

FIGS. 3A-3C are schematic illustration examples 300 of the timing stages for an exemplary intersection demonstrating how intersection timing may be calculated, according to an embodiment;

FIG. 4 illustrates a method flow 400, according to an embodiment;

FIG. 5 illustrates a method flow 500, according to an embodiment; and

FIG. 6 illustrates a method flow 600, according to an embodiment.

### DETAILED DESCRIPTION

The following text sets forth a detailed description of numerous different embodiments. However, it should be understood that the detailed description is to be construed as exemplary only and does not describe every possible embodiment since describing every possible embodiment would be impractical. In light of the teachings and disclosures herein, numerous alternative embodiments may be implemented.

It should be understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

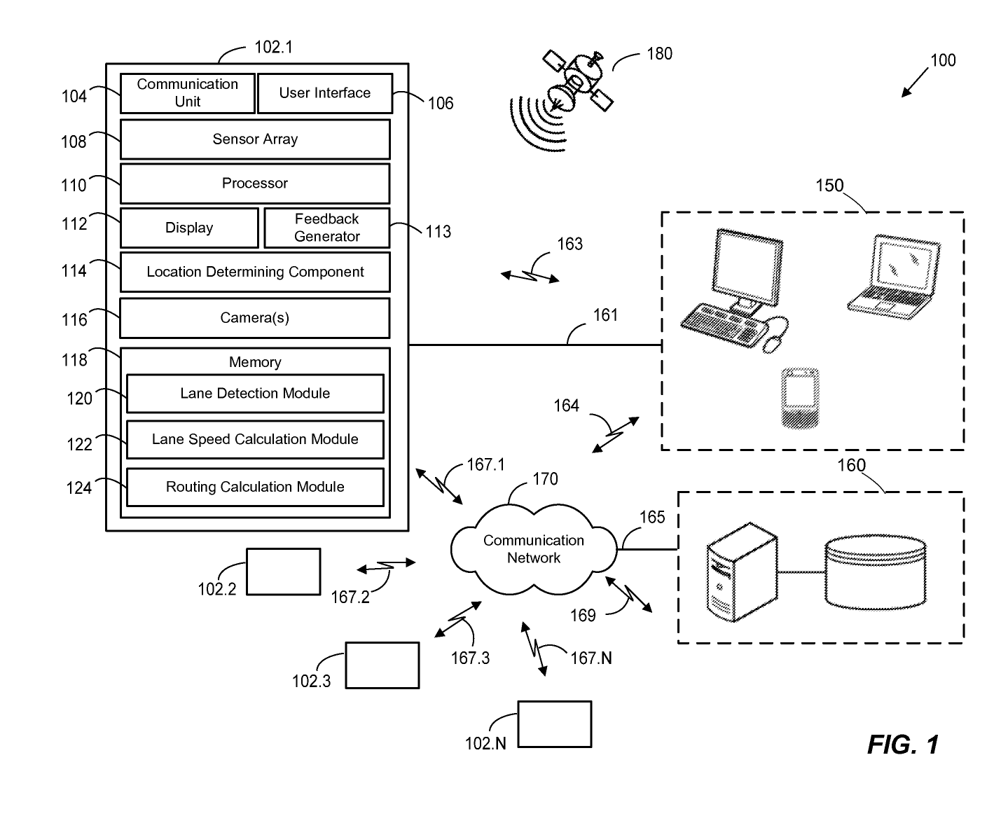

FIG. 1 is an illustration of a block diagram of an exemplary navigation system 100 in accordance with an embodiment of the present disclosure. Navigational system 100 may include any suitable number N of mobile computing devices 102.1-102.N, one or more external computing devices 150, one or more external computing devices 160, one or more communication networks 170, and one or more satellites 180.

In some embodiments, mobile computing device 102.1 may act as a standalone device and not require communications with one or more external computing devices 150 or 160. But in other embodiments, mobile computing device 102.1 may communicate with and/or work in conjunction with one or more of external computing devices 150 and/or 160.

One or more mobile computing devices 102.1-102.N, one or more external computing devices 150 and/or 160 may be configured to communicate with one another using any suitable number of communication networks in conjunction with any suitable combination of wired and/or wireless links in accordance with any suitable number and type of communication protocols.

For example, mobile computing device 102.1 and one or more external computing devices 150 may be configured to communicate with one another directly via wired link 161 and/or wireless link 163. Any of mobile computing devices 102.2-102.N may similarly communicate with one or more of external computing devices 150 and/or 160 in the same manner as shown for mobile computing device 102.1, but additional wired and/or wireless links are not shown in FIG. 1 for purposes of brevity.

To provide another example, mobile computing device 102.1 and one or more external computing devices 150 may be configured to communicate with one another via communication network 170 utilizing wireless links 167.1 and 164. To provide yet another example, mobile computing device 102.1 and one or more external computing devices 160 may be configured to communicate with one another via communication network 170 utilizing wireless link 167.1, wireless link 169, and/or wired link 165.

In various embodiments, one or more of external computing devices 150 may include any suitable number and/or type of computing devices configured to communicate with and/or exchange data with one or more of mobile computing devices 102.1-102.N. For example, one or more of external computing devices 150 may be implemented as a mobile computing device (e.g., smartphone, tablet, laptop, phablet, netbook, notebook, pager, personal digital assistant (PDA), wearable computing device, smart glasses, a smart watch or a bracelet, etc.), or any other suitable type of computing device capable of wired and/or wireless communication (e.g., a desktop computer).

In various embodiments, one or more of external computing devices 160 may include any suitable number and/or type of computing devices configured to communicate with and/or exchange data between one or more of mobile computing devices 102.1-102.N. For example, one or more of external computing devices 160 may be implemented as one or more servers, such as application servers, web servers, database servers, traffic servers, etc. To provide additional examples, one or more of external computing devices 160 may be implemented as one or more databases, networks, storage devices, etc. In an embodiment, one or more external computing devices 160 may be implemented as one or more parts of a traffic service, which is further discussed below.

In an embodiment, one or more of mobile computing devices 102.1-102.N may communicate with one or more of external computing devices 150 and/or 160 to send data to and/or to receive data from external computing devices 150 and/or 160. For example, one or more of mobile computing devices 102.1-102.N may communicate with one or more external computing devices 150 to receive updated cartographic data. To provide another example, one or more of mobile computing devices 102.1-102.N may communicate with one or more external computing devices 160 to receive aggregated traffic data and/or to send data that is collected, measured, and/or generated by each respective one or more of mobile computing devices 102.1-102.N, to external computing devices 160 (e.g., traffic data, as further discussed below).

Communication network 170 may include any suitable number of nodes, additional wired and/or wireless networks, etc., in various embodiments. For example, in an embodiment, communication network 170 may be implemented with any suitable number of base stations, landline connections, internet service provider (ISP) backbone connections, satellite links, public switched telephone network (PSTN) connections, local area networks (LANs), metropolitan area networks (MANs), wide area networks (WANs), any suitable combination of local and/or external network connections, etc. To provide further examples, communication network 170 may include wired telephone and/or cable hardware, satellite, cellular phone communication networks, etc. In various embodiments, communication network 170 may provide mobile computing device 102.1 with connectivity to network services, such as Internet services, for example.

Communication network 170 may be configured to support communications between one or more mobile computing devices 102.1-102.N, one or more external computing devices 150, and/or one or more external computing devices 160 in accordance with any suitable number and/or type of wired and/or wireless communication protocols.

Examples of suitable wireless communication protocols may include personal area network (PAN) communication protocols (e.g., BLUETOOTH), Wi-Fi communication protocols, radio frequency identification (RFID) and/or a near field communication (NFC) protocols, cellular communication protocols, Internet communication protocols (e.g., Transmission Control Protocol (TCP) and Internet Protocol (IP)), etc. Examples of suitable wired communication protocols may include universal serial bus (USB) protocols, Ethernet protocols, packet-switched computer network protocols, etc.

In various embodiments, one or more of mobile computing devices 102.1-102.N may be implemented as any suitable type of portable and/or mobile device configured to provide navigational guidance, collect traffic data, and/or transmit traffic data. Additionally or alternatively, one or more of mobile computing devices 102.1-102.N may be implemented as any suitable type of device that is mounted in, integrated within, located in, and/or otherwise associated with a respective vehicle. For example, one or more mobile computing devices 102.1-102.N may be implemented as a dedicated aftermarket mobile computing device mounted in or otherwise located in a vehicle. To provide another example, one or more mobile computing devices 102.1-102.N may be implemented as smartphones having a specific application installed thereon to facilitate the functions of the embodiments described herein.

In various embodiments, one or more mobile computing devices 102.1-102.N may implement some portions (or the entirety of) the embodiments described herein without implementing others. For example, one or more of mobile computing devices 102.1-102.N may be configured as active devices functioning as traffic probes, sending collected data to external computing devices 160, and/or as passive devices that receive communications from external computing device 160 but do not function as traffic probes. In various embodiments, mobile computing devices 102.1-102.N may include any suitable combination of active devices, passive devices, and mobile computing devices that perform both active and passive traffic probe functions.

The details of one of mobile computing devices 102.1-102.N is shown in further detail in FIG. 1 and various embodiments discussed through this disclosure with reference to navigation unit 102.1. The embodiments described herein are done so with reference to mobile computing device 102.1 as an example, but may be equally applicable to any of mobile computing devices 102.1-102.N. Furthermore, embodiments include one or more of mobile computing devices 102.1-102.N having differing structures, elements, functions, etc.

In an embodiment, mobile computing device 102.1 may include a communication unit 104, a user interface 106, a sensor array 108, one or more processors 110, a display 112, a feedback generator 113, a location determining component 114, one or more cameras 116, and a memory 118. Mobile computing device 102.1 may include additional elements or fewer elements as shown in FIG. 1. For example, one or more processors 110 may include and/or perform the functions otherwise performed by location determining component 114, which may be integrated as a single processing component. To provide another example, mobile computing device 102.1 may include power sources, memory controllers, memory card slots, ports, interconnects, etc., which are not shown in FIG. 1 or described herein for purposes of brevity.

Communication unit 104 may be configured to support any suitable number and/or type of communication protocols to facilitate communications between mobile computing device 102.1 and one or more additional devices. For example, communication unit 104 may facilitate communications between mobile computing device 102.1 and one or more vehicle communication systems (e.g., via BLUETOOTH communications) of the vehicle in which mobile computing device 102.1 is mounted or otherwise located. A vehicle is not shown in FIG. 1 for purposes of brevity. To provide additional examples, communication unit 104 may be configured to facilitate communications between mobile computing device 102.1 and one or more of external computing devices 150 and/or one or more of external computing devices 160.

Communication unit 104 may be configured to receive any suitable type of information via one or more of external computing devices 150 and/or 160, and communication unit 104 may likewise be configured to transmit any suitable type of information to one or more of external computing devices 150 and/or 160. Communication unit 104 may be implemented with any suitable combination of hardware and/or software to facilitate this functionality. For example, communication unit 104 may be implemented having any suitable number of wired and/or wireless transceivers, ports, connectors, antennas, etc.

Communication unit 104 may be configured to facilitate communications with various external computing devices 150 and/or external computing devices 160 using different types of communication protocols. For example, communication unit 104 may communicate with a mobile computing device via a wireless BLUETOOTH communication protocol (e.g., via wireless link 163) and with a laptop or a personal computer via a wired universal serial bus (USB) protocol (e.g., via wired link 161). To provide another example, communication unit 104 may receive communications from one or more external computing devices 160 via network 170 using a common alerting protocol (CAP) transmitted by one or more external computing devices 160 via a conventional frequency modulation (FM) radio broadcast, as part of a digital audio broadcast (DAB) (e.g., a high definition digital radio broadcast), and/or satellite radio broadcast (e.g., via links 167.1-169). Communication unit 104 may be configured to support simultaneous or separate communications between two or more of external computing devices 150 and/or 160.

User interface 106 may be configured to facilitate user interaction with mobile computing device 102.1 and/or to provide user feedback. In some embodiments, a user may interact with user interface 106 to change various modes of operation, to initiate certain functions, to modify settings, set options, etc. In other embodiments, however, mobile computing device 102.1 may not include a user interface. For example, user interface 106 may not be required when mobile computing device 102.1 is integrated and/or installed in a vehicle and/or functions solely as a passive traffic probe, as user interaction with mobile computing device 102.1 is not needed for such implementations.

For example, user interface 106 may include a user-input device such as an interactive portion of display 112 (e.g., a “soft” keyboard, buttons, etc.), physical buttons integrated as part of mobile computing device 102.1 that may have dedicated and/or multi-purpose functionality, etc. To provide another example, user interface 106 may cause visual alerts to be displayed via display 112 and/or audible alerts to be sounded via feedback generator 113.

To provide another example, user interface 106 may work in conjunction with a microphone that is implemented as part of sensor array 108 to analyze a user's voice and to execute one or more voice-based commands. Voice commands may be received and processed, for example, in accordance with any suitable type of automatic speech recognition (ASR) algorithm.

Sensor array 108 may be implemented as any suitable number and/or type of sensors configured to measure, monitor, and/or quantify one or more characteristics of mobile computing device 102.1's environment as sensor metrics. For example, sensor array 108 may measure sensor data metrics such as magnetic field direction and intensity (e.g., to display a compass direction).

Sensor array 108 may be advantageously mounted or otherwise positioned within mobile computing device 102.1 to facilitate these functions. Sensor array 108 may be configured to sample sensor data metrics and/or to generate sensor data metrics continuously or in accordance with any suitable recurring schedule, such as, for example, on the order of several milliseconds (e.g., 10 ms, 100 ms, etc.), once per every second, once per every 5 seconds, once per every 10 seconds, once per every 30 seconds, once per minute, etc.

Examples of suitable sensor types implemented by sensor array 108 may include one or more accelerometers, gyroscopes, compasses, speedometers, magnetometers, barometers, thermometers, proximity sensors, light sensors (e.g., light intensity detectors), photodetectors, photoresistors, photodiodes, Hall Effect sensors, electromagnetic radiation sensors (e.g., infrared and/or ultraviolet radiation sensors), ultrasonic and/or infrared range detectors, humistors, hygrometers, altimeters, microphones, radio detection and ranging (RADAR) systems, light RADAR (LiDAR) systems, etc.

Display 112 may be implemented as any suitable type of display configured to facilitate user interaction with mobile computing device 102.1, such as a capacitive touch screen display, a resistive touch screen display, etc. In various aspects, display 112 may be configured to work in conjunction with user interface 106 and/or processor 110 to detect user inputs upon a user selecting a displayed interactive icon or other graphic, to identify user selections of objects displayed via display 112, to receive a user-selected destination, etc.

Feedback generator 113 may include any suitable device, or combination of suitable devices, configured to provide user feedback. For example, feedback generator may be implemented as a speaker integrated into mobile computing device 102.1 and/or one or more speakers of a vehicle in which mobile computing device 102.1 may communicate (e.g., the vehicle in which mobile computing device 102.1 is mounted). To provide additional examples, feedback generator 102.1 may cause communication unit 104 to send one or more signals, commands, etc., to one or more feedback generators that are implemented as part of the vehicle in which mobile computing device 102.1 is mounted. For example, feedback generator 113 may cause (e.g., via communications sent by communication unit 104) one or more vibration components embedded in a vehicle seat or a vehicle steering wheel to vibrate to alert the user alternatively or in addition to audible notifications and/or alerts sounded via a speaker.

Location determining component 114 may be implemented as a satellite navigation receiver that works with a global navigation satellite system (GNSS) such as the global positioning system (GPS) primarily used in the United States, the GLONASS system primarily used in Russia, the BeiDou system primarily used in China, and/or the Galileo system primarily used in Europe. The GNSS includes a plurality of satellites 180 in orbit about the Earth. The orbit of each satellite is not necessarily synchronous with the orbits of other satellites and, in fact, is likely asynchronous.

In FIG. 1, a GNSS equipped device, such as mobile computing device 102.1, is shown receiving spread spectrum satellite signals from the various satellites 180. The spread spectrum signals continuously transmitted from each satellite may use a highly accurate frequency standard accomplished with an extremely accurate atomic clock. Each satellite 180, as part of its data signal transmission, may transmit a data stream indicative of that particular satellite. Mobile computing device 102.1 may acquire spread spectrum satellite signals from at least three satellites 180 for the receiver device to calculate its two-dimensional position by triangulation. Acquisition of an additional signal, resulting in signals from a total of four satellites 180, permits mobile computing device 102.1 to calculate its three-dimensional position.

Location determining component 114 and processor 110 may be configured to receive navigational signals from the satellites 180 and to calculate positions of mobile computing device 102.1 as a function of the signals. Location determining component 114 and processor 110 may also determine track logs or any other series of geographic location data (e.g., geographic coordinates) corresponding to points along a route or other path traveled by a user of mobile computing device 102.1 and/or a device in which mobile computing device 102.1 is mounted or otherwise positioned (e.g., a vehicle). Location determining component 114 and/or processor 110 may also be configured to calculate routes to desired locations, provide instructions to navigate to the desired locations, display maps and other information on display 112, and/or execute other functions described herein.

Location determining component 114 may include one or more processors, controllers, or other computing devices and memory to calculate a geographic location and other geographic information without processor 110, or location determining component 114 may utilize components of processor 110. Further, location determining component 114 may be integral with processor 110 such that location determining component 114 may be operable to specifically perform the various functions described herein. Thus, the processor 110 and location determining component 114 may be combined or be separate or otherwise discrete elements.

Location determining component 114 may include an antenna to assist in receiving the satellite signals. The antenna may be a patch antenna, a linear antenna, or any other suitable type of antenna that can be used with navigational devices. The antenna may be mounted directly on or in the housing of mobile computing device 102.1, or may be mounted external to the housing of mobile computing device 102.1. An antenna is not shown in FIG. 1 for purposes of brevity.

Although embodiments of mobile computing device 102.1 may include a satellite navigation receiver, it will be appreciated that other location-determining technology may be used. For example, communication unit 104 may be used to determine the location of mobile computing device 102.1 by receiving data from at least three transmitting locations and then performing basic triangulation calculations to determine the relative position of mobile computing device 102.1 with respect to the transmitting locations. For example, cellular towers or any customized transmitting radio frequency towers may be used instead of satellites 180. With such a configuration, any standard geometric triangulation algorithm may be used to determine the location of mobile computing device 102.1.

In other embodiments, location determining component 114 need not directly determine the current geographic location of mobile computing device 102.1. For instance, location determining component 114 may determine the current geographic location of mobile computing device 102.1 through a communications network, such as by using Assisted Global Positioning System (A-GPS) by receiving communications from a combination of base stations and/or satellites 180, or from another electronic device. Location determining component 114 may even receive location data directly from a user. For example, a user may obtain location data for a physical activity before and after it has been completed from another satellite navigation receiver or from another source and then manually input the data into mobile computing device 102.1.

One or more cameras 116 may be configured to capture pictures and/or videos, to generate live video data, and/or store the live video data in a suitable portion of memory 118. In an embodiment, one or more cameras 116 may include any suitable combination of hardware and/or software such as image sensors, optical stabilizers, image buffers, frame buffers, charge-coupled devices (CCDs), complementary metal oxide semiconductor (CMOS) devices, etc., to facilitate this functionality.

In an embodiment, one or more cameras 116 may be housed within or otherwise integrated as part of mobile computing device 102.1. One or more cameras 116 may be strategically mounted on mobile computing device 102.1 to capture live video towards the front of a vehicle in which mobile computing device 102.1 is mounted and to generate live video data of the road lanes of a road on which the vehicle is currently travelling. For example, one or more cameras 116 may be mounted on a side of mobile computing device 102.1 that is opposite of display 112, allowing a user to view display 112 while one or more cameras 116 captures live video and generates and/or stores the live video data.

In other embodiments, one or more cameras 116 may not be integrated as part of mobile computing device but factory installed as part of the vehicle (e.g., in the front grill or on top of the roof). In accordance with such embodiments, the images and/or video data captured by one or more cameras 116 may be received, for example, as data via communication unit 104.

Processor 110 may be implemented as any suitable type and/or number of processors, such as a host processor of mobile computing device 102.1, for example. To provide additional examples, processor 110 may be implemented as an application specific integrated circuit (ASIC), an embedded processor, a central processing unit (CPU) associated with mobile computing device 102.1, a graphical processing unit (GPU), etc.

Processor 110 may be configured to communicate with one or more of communication unit 104, user interface 106, sensor array 108, display 112, feedback generator 113, location determining component 114, one or more cameras 116, and/or memory 118 via one or more wired and/or wireless interconnections, such as any suitable number of data and/or address buses, for example. These interconnections are not shown in FIG. 1 for purposes of brevity.

Processor 110 may be configured to operate in conjunction with one or more of communication unit 104, user interface 106, sensor array 108, display 112, location determining component 114, feedback generator 113, one or more cameras 116, and/or memory 118 to process and/or analyze data, to store data to memory 118, to retrieve data from memory 118, to display information on display 112, to cause instructions, alerts and/or notifications to be sounded via feedback generator 113, to receive, process, and/or interpret sensor data metrics from sensor array 108, to process user interactions via user interface 106, to receive and/or analyze live video data captured via one or more cameras 116, to determine a current number of vehicle lanes on a road, to generate vehicle speed and/or heading data indicative of the speed of the vehicle, to determine a road lane in which the vehicle that mobile computing device 102.1 is located is travelling, to generate vehicle lane data indicative of the road lane in which the vehicle is travelling, to calculate driving routes, to calculate driving route arrival times, to receive data from and/or send data to one or more of external computing devices 150 and/or 160, etc.

In accordance with various embodiments, memory 118 may be a computer-readable non-transitory storage device that may include any suitable combination of volatile memory (e.g., a random access memory (RAM) or non-volatile memory (e.g., battery-backed RAM, FLASH, etc.). Memory 118 may be configured to store instructions executable on processor 110, such as the various memory modules illustrated in FIG. 1 and further discussed below, for example. These instructions may include machine readable instructions that, when executed by processor 110, cause processor 110 to perform various acts as described herein.

Memory 118 may also be configured to store any other suitable data used in conjunction with mobile computing device 102.1, such as data received from one or more of external computing devices 150 and/or 160 via communication unit 104 (e.g., aggregated traffic data), sensor data metrics from sensor array 108, historical road lane speed and/or heading data values, information processed by processor 110, live video data, cartographic data, etc.

Memory 118 may include a first portion implemented as integrated, non-removable memory and a second portion implemented as a removable storage device, such as a removable memory card. For example, memory 118 may include a SD card that is removable from mobile computing device 102.1 and a flash memory that is not removable from mobile computing device 102.1. Data may be transferred from a first portion of memory 118 (e.g., live video data) to a second portion of memory 118, thereby allowing a user to remove a portion of memory 118 to access viewing data stored thereon on another device.

Lane detection module 120 is a region of memory 118 configured to store instructions that, when executed by processor 106, cause processor 110 to perform various acts in accordance with applicable embodiments as described herein.

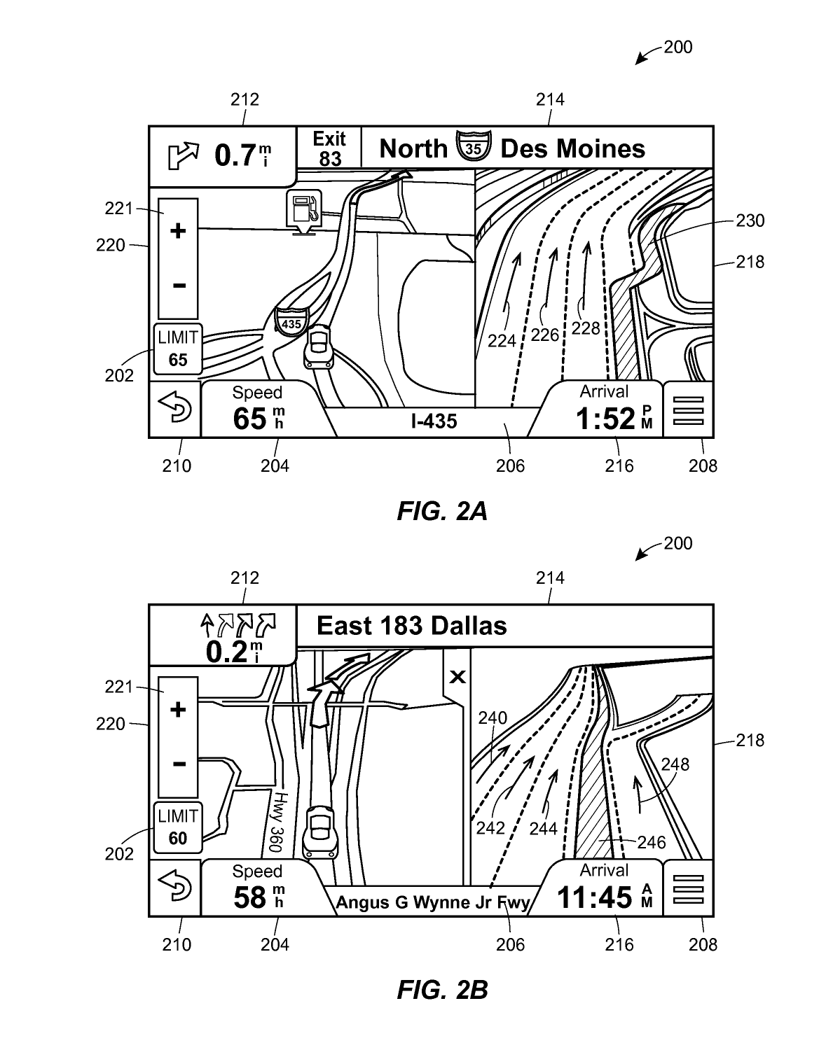

In an embodiment, lane module 120 includes instructions that, when executed by processor 110, cause processor 110 to analyze live video data generated via one or more cameras 116 to determine a lane occupied by a vehicle in which mobile computing device 102.1 is mounted, to identify adjacent road lane lines as dashed or a solid road lane lines, and/or to generate vehicle lane data indicative of the road lane. These functions are further discussed below with respect to FIGS. 2A-2B.

In an embodiment, processor 110 may execute instructions stored in lane detection module 120 to analyze the live video data in accordance with any suitable number and/or type of machine vision algorithms to detect road lane lines adjacent to the vehicle and to determine whether the road lane lines are dashed or solid road lane lines. For example, processor 110 may analyze the live video data using any suitable edge detection techniques, such as a Canny edge detection technique or other suitable types of search-based or zero-crossing based techniques that analyze variations in contrast. As a result of the applied edge-detection, processor 110 may identify line segments within the live video data.

Once line segments are identified, embodiments include processor 110 identifying a vanishing point within the live video data based upon a convergence of identified line segments having a particular length longer than other identified line segments, which may be represented by exceeding a number of pixels within the live video data, for example. For example, solid and dashed road lane lines may have pixel dimensions of a threshold size that are greater than other identified line segments within the live video data.

After identifying the vanishing point within the live video data, embodiments include processor 110 executing instructions stored in lane detection module 120 to compensate for the position of mobile computing device 102.1 within the vehicle based upon the identified vanishing point. That is, mobile computing device 102.1 may be mounted on the left, center, or right of a dashboard within a vehicle. Without knowledge of the vanishing point, it is difficult to ascertain a reference point to identify road lane lines with respect to the vehicle, as a left-mounted mobile computing device may record live video showing a left line closer than it actually is. But with knowledge of the vanishing point within the live video data, processor 110 may establish a reference point by mapping the vanishing point to the current lane in which the vehicle is traveling, thereby compensating for image skewing and/or various positions of mobile computing device 102.1.

In some embodiments, a user may further assist this compensation process by specifying the mounting position of mobile computing device 102.1 on the dashboard (e.g., as left, center, or right) via user interface 106. In accordance with such embodiments, processor 110 may utilize this selection to further compensate for the position of mobile computing device 102.1 to identify the road lane lines.

For example, when a left-mounting configuration is entered by a user, processor 110 may adjust for the road lane lines to the right and left of the vehicle appearing closer to the left within the live video data. In an embodiment, processor 110 may apply left, center, and right compensating profiles whereby this offset is accounted for via a predetermined offset number of pixels, the live video data shifting the road lane lines by a preset amount based upon the profile selection when the images are processed, etc.

In some embodiments, processor 110 may execute instructions stored in lane detection module 120 to utilize the vanishing point as a reference point, and to identify lines adjacent to those used to establish the vanishing point as the road lane lines to the left and right of the vehicle. In other words, a “reference” lane may be determined using the lines adjacent to the vehicle to identify a current lane in which the vehicle is traveling. Based upon this reference lane, processor 110 may identify the shape of other nearby parallel road lane lines, the overall shape of the road, and the number of total road lanes.

In other embodiments, the shape of the road and/or the number of road lanes may be determined via processor 110 executing instructions stored in lane detection module 120, but may not rely upon the actual shape and/or presence of road lane lines. For example, instructions stored in lane detection module 120 may facilitate one or more object recognition techniques to identify, from images captured via one or more cameras 116, physical road barriers, shoulders, rumble strips, curbs, etc. To provide another example, instructions stored in lane detection module 120 may facilitate the detection of road lane line markers that are present in the road but not visible, such as magnetically marked road lane boundaries that may detected, for example, via one or more components of sensor array 108.

Additionally or alternatively, processor 110 may execute instructions stored in lane detection module 120 to improve upon the accuracy that mobile computing device 102.1 identifies a current road. For example, some roads may be close together, run parallel to one another at the same level, or run parallel with one another at varying elevations. Typical GNSS-based systems may have difficulty discerning which road a vehicle is currently travelling, especially in dense urban environments. Thus, in some embodiments, processor 110 may execute instructions stored in lane detection module 120 to analyze images captured via one or more cameras 116 to discern between adjacent roads and assist in determining the location of the vehicle in the correct lane. The cartographic map data may be further utilized as part of this process. For example, if the map data indicates that an upper road has two lanes and a lower road has 3 lanes, then processor may correlate this information to the number of road lanes for the present road, thereby determining the correct current lane.

In an embodiment, processor 110 may execute instructions stored in lane detection module to determine the number of road lane lines from the live video data by categorizing the identified road lane lines within the live video data as dashed and solid lines. This categorization may be utilized to identify the number of road lane lines and/or the identification of the current road lane occupied by the vehicle in which mobile computing device 102.1 is located. For example, if the analysis of the live video data indicates solid lines on the outside of the road with three parallel dashed lines between them, processor 110 may calculate that the current road has 4 road lanes. The reference lane may be compared to the four different lanes such that the vehicle's current lane may be determined based upon the relationship of the parallel lines to one another.

The discrimination between solid and dashed road lane lines may be performed, for example, via a comparison of the number of occupied pixels with respect to the height and/or width of the captured live video data. Identified lane lines occupying a greater pixel length may be classified as solid lane lines, while identified lane lines occupying fewer pixels may be classified as dashed lane lines. In an embodiment, any suitable threshold may be selected as the number of pixel to facilitate the differentiation between solid and dashed lane lines.

Additionally or alternatively, processor 110 may utilize other road lane line characteristics to facilitate the number of lanes and/or the determination of which if these lanes the vehicle in which mobile computing device 102 is currently travelling. For example, embodiments include the identification of road lane line colors as yellow or white. Because a road may not have a physical barrier dividing different traffic directions, these embodiments may be particularly useful in the identification of the proper number of road lanes for a given direction of traffic versus the road lane lines for oncoming traffic. For example, processor 110 may execute instructions stored in lane detection module 120 to determine the number of road lanes within two yellow road lane lines, thereby excluding road lane lines for oncoming traffic.

In some embodiments, processor 110 may execute instructions stored in lane detection module 120 to additionally or alternatively utilize cartographic data to determine the number of road lanes. For example, mobile computing device 102.1 may store cartographic data in memory 118 used for route calculations. This cartographic data may include, for example, road types (e.g., one-way, highway, freeway, tollway, divided highway, etc.) an indication of the number of lanes, map data used in conjunction with the geographic location data, etc.

In embodiments, mobile computing device 102.1 may use the cartographic data stored in memory 118 to determine which lane “type” the vehicle is traveling in (e.g., left, center, or right) without having to visually identify all of the road lanes that may be traversed by a vehicle. For instance, lane detection module 120 may utilize the visual lane classification to determine that the lane line to the left of the vehicle is solid and the lane line to the right is dashed and the stored cartographic data to determine that there are one or more lanes travelling in the same direction to determine that the user is travelling in the left-most lane for the current road. Similarly, lane detection module 120 may utilize the visual lane classification to determine that both the left and right lane lines are dashed and the stored cartographic data to determine that there are two or more lanes travelling in the determined heading of the user's vehicle to determine that the vehicle is travelling in one of the center lanes (i.e., the vehicle is determined not to be traversing the road using the left-most or right-most lanes).

In an embodiment, processor 110 may reference the cartographic data to the geographic location data to determine the number of road lanes for the current road on which the vehicle (in which mobile computing device 102.1 is mounted) is travelling. Therefore, embodiments include processor 110 calculating a number of road lanes via analysis of the live video data and/or by referencing the cartographic data to the geographic location data.

In an embodiment, processor 110 may execute instructions stored in lane detection module 120 to generate road lane data to indicate the current road. This road lane data may include, for example, an indication of the current vehicle lane relative to the other road lanes on the road, which may be ascertained via analysis of live video data captured via one or more cameras 116 and/or via referencing the cartographic data to the geographic location data. The road lane data may additionally or alternatively include data indicative of other road and/or intersection characteristics.

For example, instructions stored in lane detection module 120 may facilitate identifying, utilizing one or more object recognition techniques, an intersection entry point when a white block exists on the pavement in front of a vehicle, indicating that a stop line is present in the intersection. Mobile computing device 102.1 may transmit this information along with or as part of the road lane data, which may be used by mobile computing device 102.1 and/or one or more external computing devices 160 in conjunction with the intersection timing data (further discussed below) as part of the route calculation process.

To provide another example of what may be transmitted as part of the road lane data, on a three lane road, the road lane data may include an indication that the road has three lanes and that, from these three lanes, the current lane may be identified as the left, center, or right lane. Embodiments include the road lane data including these types of indications for any suitable number of road lanes. However, in some embodiments, the current road lane may represent a road lane grouping versus an individual lane. For example, a vehicle in which mobile computing device 102.1 is located may be travelling down a road having 5 road lanes. Processor 110 may determine that the vehicle is located in the second lane from the left of a total of 5 road lanes. In this scenario, the road lane data may include an indication that the road has 5 lanes grouped into 2 left lanes, a center lane, and 2 right lanes, and that the vehicle is currently travelling in the left lane group.

Embodiments in which lane groupings are used may be particularly useful for roads having a greater number of lanes, as an analysis of the live video data may produce less accurate results for greater number of road lanes. Additionally, a road having a greater number of lanes will likely support a greater number of vehicles travelling on that road, which may include additional mobile computing devices 102.1-102.N reporting their own lane road lane data. Therefore, this lane grouping allows for the majority of skewing introduced by averaging road lane speeds over all road lanes to be eliminated while still maintaining a desired resolution for providing lane-level speed and/or heading data.

In an embodiment, processor 110 may execute instructions stored in lane detection module 120 to determine the speed of the vehicle, for example, based upon changes in the geographic location data over a certain time period. Communication device 104 may transmit this vehicle speed and/or heading data, which is indicative of the speed of the vehicle while travelling in a particular road lane, and/or a direction that the vehicle is travelling, respectively, to an external computing device (e.g., one or more external computing devices 160) with the road lane data. Communication device 104 may also transmit the geographic location data indicative of the location of mobile computing device 102.1 (e.g., the geographic locations used to determine the vehicle speed). In an embodiment, the vehicle speed and/or heading data, the road lane data, and the geographic location data may be transmitted in a manner such that, when received by the traffic service provider, the speed and/or heading data be correlated to the road lane for a road location specified by the geographic location data.

Because mobile computing devices 102.2-102.N may be mounted in any suitable number of vehicles travelling on the same road, the traffic service may also receive vehicle speed and/or heading data, road lane data, and geographic location data from one or more of mobile computing devices 102.2-102.N. The traffic service may use this data to identify vehicles travelling in the same road lane (or same road lane group) and average the speeds for each of the vehicles in this group. In this way, the traffic service may calculate an average vehicle speed on a per-road lane basis. The traffic service may broadcast aggregated traffic data, which may include the average vehicle lane speed and an identification of its corresponding road lane, geographic location data corresponding to the geographic location of the road for which the average vehicle lane speed and/or heading data is applicable, and/or other data, such as intersection timing data, which may be received by one or more mobile computing devices and used to improve routing calculations, which is further discussed below.

Lane speed calculation module 122 is a region of memory 118 configured to store instructions, that when executed by processor 110, cause processor 110 to perform various acts in accordance with applicable embodiments as described herein.

In an embodiment, lane speed calculation module 122 includes instructions that, when executed by processor 110, cause processor 110 to receive aggregated traffic data from an external computing device (e.g., one or more of external computing devices 160), and to use this data to calculate average lane speeds, which may be displayed in any suitable manner via display 112.

Processor 110 may execute instructions stored in lane speed calculation module 122 to assign each average vehicle lane speed to an appropriate lane based upon the corresponding road lane included in the broadcasted aggregated traffic data. In an embodiment, processor 110 may store the average vehicle lane speed and/or heading data in any suitable portion of memory 118, cause display 112 to display the average vehicle lane speed in any suitable format, which is further discussed below, etc.

Additionally or alternatively, one or more vehicles' lane speed and heading may be utilized in conjunction with one another to provide mobile computing device 102.1 with additional functionality. For example, processor 110 may execute instructions stored in lane speed calculation module 122 to issue warnings, alerts, and/or notifications (e.g., via display 112 and/or feedback generator 113) to indicate that the user's present lane speed and/or heading poses a lane-departure hazard and/or that a certain road lane is blocked.

In an embodiment, one or more external computing devices 160 may generate and/or store a historical database that includes the individual lane speeds of various vehicles correlated to their individual road lane locations. In this way, one or more external computing devices 160 may store data that indicates whether one or more vehicles within various speeds and headings have departed certain road lanes when travelling within a certain range of speeds and/or headings.

In accordance with embodiments in which one or more external computing devices 160 generate historical lane departure databases, processor 110 may execute instructions stored in lane speed calculation module 122 to compute the derivative of the vehicle's velocity to determine the vehicle's acceleration and/or perform other calculations using the speed and/or heading data to calculate angular velocity, momentum, etc. Processor 110 may utilize these computations to determine whether a vehicle is at a risk of an imminent lane departure based upon the vehicle's current speed and/or heading compared to the lane departure data that is archived into the historical database of lane departures generated by one or more external computing devices 160, and cause a warning to be issued when such a risk is detected.

To provide an illustrative example, a curved lane at the bottom of a hill may pose a lane departure risk if the vehicle is approaching the bottom of the hill at a speed greater than some threshold correlated with a lane departure for vehicles over 50% of the time for that speed approaching the road lane. To provide another example, processor 110 may calculate that the vehicle's angular velocity is outside of a computed range associated with more vehicles departing the lane more than 50% of the time.

In another embodiment, one or more of external computing devices 160 may calculate a correlated group of sudden decelerations from various mobile computing devices 102.1-102.N (e.g., those exceeding some threshold value) using the lane speed and/or heading data for a given road lane and/or abrupt lane departures at a given location. One or more external computing devices 160 may utilize this data to determine that a specific lane is blocked, and transmit a notification to one or more mobile computing devices 102.1-102.N as part of the broadcasted aggregated traffic data.

Routing calculation module 124 is a region of memory 118 configured to store instructions, that when executed by processor 110, cause processor 110 to perform various acts in accordance with applicable embodiments as described herein.

In an embodiment, routing calculation module 124 includes instructions that, when executed by processor 110, cause processor 110 to calculate navigational routes on a road-lane level and to calculate route driving times (e.g., arrival times) associated with the calculated driving routes, taking into consideration the average speeds calculated for each road lane. Additionally or alternatively, embodiments include processor 110 calculating route driving times by using the time it takes for vehicles in various road lanes to pass through various intersections along the driving route, which may be calculated from the intersection timing data received from one or more external computing devices 160 and further discussed below.

For example, embodiments include processor 110 executing instructions stored in routing calculation module 124 to calculate one or more navigation routes based upon the current geographic location of mobile computing device 102 and another location, such as a destination address entered by a user via user interface 106, for example. Because processor 110 may obtain average road lane speed and/or heading data from the broadcasted aggregated traffic data, processor 110 may select (or allow a user to select) the route having the fastest average road lane speeds and use this selected route for navigational guidance.

Additionally or alternatively, while driving along the calculated route, embodiments include processor 110 issuing an alert indicating that road lanes with especially slow average road lane speeds should be avoided. For example, display 112 may display a notification to avoid a specific road lane (or road lane group) when the road lane (or road lane group) has an average road lane speed below a threshold speed. For example, the notification may indicate “keep left to avoid slow lanes on the right,” etc. Additionally or alternatively, alerts may be in the form of audible announcements made via feedback generator 113 (e.g., via a speaker, via vibration alerts integrated into the vehicle in which mobile computing device 102.1 is mounted, etc.).

Because processor 110 calculates the driving route at a road lane level of granularity, the total route driving time for the selected route may be calculated using the recommended road lanes, for which an average road lane speed may be calculated. Therefore, the calculated total route driving time may be more accurate when the average road lane speed is taken into consideration compared to simply using an overall average road lane speed for each road in the driving route. For example, processor 110 may execute instructions stored in routing calculation module 124 to analyze lane speeds available in the vicinity around and between the origin (e.g., the current location of mobile computing device 102.1) and the destination, and choose an optimal route based upon the optimal path using the road lane speed data available to mobile computing device 102.1.

In various embodiments, a driving route may be calculated using any suitable combination of mobile computing device 102.1 and/or one or more external computing devices 160. For example, as described above, one or more mobile computing devices 102.1-102.N may receive the average road lane speed and/or heading data from the broadcasted aggregated traffic data, and processor 110 may execute instructions stored in routing calculation module 124 to calculate a driving route.

But in other embodiments, one or more external computing devices 160 may calculate a route for one or more mobile computing devices 102.1-102.N and transmit the calculated route to one or more external computing devices 160. Such embodiments may be particularly useful, for example, to offload this processing when one or mobile computing devices 102.1-102.N has limited processing power. Such embodiments may also be particularly useful when, for example, one or more of external computing devices 160 has faster and/or more complete access to the road lane speed and/or heading data compared to the data that may be sent to one or more mobile computing devices 102.1-102.N via communication network 170.

In yet additional embodiments, one or more of mobile computing devices 102.1-102.N and one or more external computing devices 160 may respectively calculate each of their own driving routes. For example, mobile computing device 102.1 may calculate a first driving route and send this calculated driving route to one or more external computing devices 160. One or more external computing devices 160 may calculate a second driving route, which may be based upon a larger set of road lane speed and/or heading data (e.g., from more mobile computing devices 102.1-102.N) than the data used by mobile computing device 102.1 to calculate the first driving route. One or more external computing devices 160 may receive the first driving route, compare it to its own second driving route, and send the second driving route to mobile computing device 102.1 in the event that the second driving route is faster, more optimized, based upon a larger set of road lane speed and/or heading data, etc.

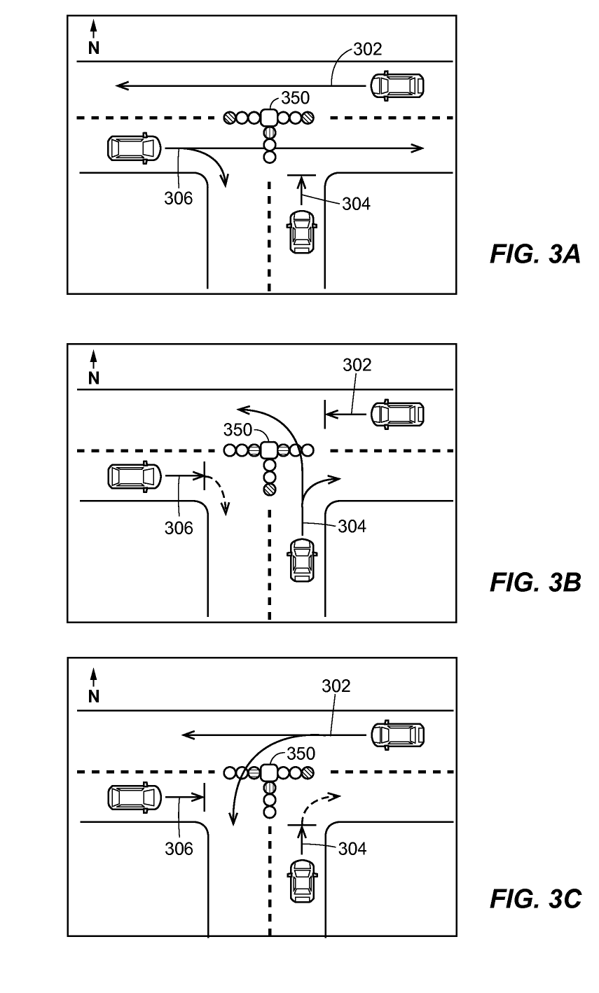

To further increase the accuracy of the calculated total route driving time, embodiments include processor 110 executing instructions stored in routing calculation module 124 to compensate for the time required for vehicles to pass through traffic intersections included the driving route, which is further discussed below with reference to FIGS. 3A-3C.

In some embodiments, the time required for vehicles to pass through traffic intersections may be included in or calculated from the traffic intersection timing data, which may be part of the aggregated traffic data broadcasted by one or more external computing devices 160.

For example, the traffic intersection timing data may be aggregated by one or more external computing devices in a similar manner as the lane speed and/or heading data. For example, one or more mobile computing devices 102.1-102.N may measure the geographic location of intersections and the time required to pass through each respective intersection while travelling in a specific road lane (or road lane group). One or more of mobile computing devices 102.1-102.N may transmit this information with the vehicle lane speed and/or heading data and the geographic location data to one or more external computing devices 160, which may collect the intersection timing data from various mobile computing devices 102.1-102.N, average the times for vehicles in the same road lane when passing through the same intersection, and broadcast the averaged intersection timing data as part of the aggregated traffic data.

In an embodiment, processor 110 may optimize a calculated driving route by selecting a driving route having intersections with the fastest averaged intersection timing data. Furthermore, in some embodiments, processor 110 may consider both average road lane speed and average road lane traffic timing to minimize the route driving time. For example, although some road lanes may have average road lane speeds faster than others, the averaged intersection timing data for some intersections may be considerably slower for some road lanes than others. Therefore, processor 110 may execute instructions stored in routing calculation module 124 to calculate a driving route by selecting a combination of road lanes and intersections that provide the fastest driving route.

In an embodiment, the aforementioned actions performed by one more mobile computing devices 102.1-1.N may be triggered based upon certain conditions being satisfied. For example, mobile computing device 102.1 may initially perform functions in accordance with a standard navigation device, but perform the enhanced functions of lane speed calculations and/or routing calculations when one or more trigger conditions are satisfied. These trigger conditions may be based, for example, upon the confidence, quality, and/or grade of the aggregated traffic data. That is, one or more mobile computing devices 102.1-102.N may transmit an indication of its hardware configuration to one or more external computing devices 160, which may be associated with a low grade (e.g., triangulation only), medium grade (e.g., GPS data but not map data), or high grade (e.g., GPS data and map data).

The aggregated traffic data, therefore, may likewise be associated with a certain grade level based upon the number of grades of each of mobile computing devices 102.1-102.N that has contributed to the aggregated traffic data. The aggregated data may additionally or alternatively be associated with a certain grade based upon a number of mobile computing devices 102.1-102.N contributing to the aggregated traffic data, regardless of their individual grades. In an embodiment, one or more of mobile computing devices 102.1-102.N may perform enhanced navigation functions when the grade level associated with the aggregated traffic data exceeds a threshold value or is aggregated from a number of mobile computing devices exceeding a threshold number, and otherwise not perform the enhanced navigation functions.

Additionally or alternatively, one or more of mobile computing devices 102.1-102.N may share their vehicle type with one or more external computing devices 160. For example, one or more of mobile computing devices 102.1-102.N may include, with or in addition to the data transmitted to one or more external computing devices 160, an indication of a type of vehicle in which the mobile computing device is installed, such as a truck, for example. Continuing this example, some roads may not allow trucks or may only allow trucks, and truck routes may be different than vehicle routes based on different lane speeds for different vehicle types, as trucks are typically required to stay in right lanes and, when ascending mountains, take longer than cars on the same route. Thus, embodiments include one or more external computing devices 160 utilizing information identifying the type of vehicle associate with one or more mobile computing devices 10.1-102.N to exclude, from the aggregated traffic data, data inapplicable to other vehicle types (e.g., if the only vehicle probe is a truck climbing a mountain road, then the overall road speed should not be biased by the truck speed).

FIGS. 2A-2B are schematic illustration examples of user interface screens 200, according to an embodiment. In an embodiment, user interface screens 200 are examples of what may be displayed on display 112 of mobile computing device 102.1, as shown and previously discussed with respect to FIG. 1. In this embodiment and the additional ones disclosed herein, user interaction with various portions of user interface screens 200 is discussed in terms of various screen portions being “selected” by a user. These selections may be performed via any suitable gesture, such as a user tapping her finger (or stylus) to that portion of the screen, via a voice command that is processed via an automatic speech recognition algorithm, etc.

As shown in FIG. 2A, user interface screen 200 includes portions 202, 204, 206, 208, 210, 212, 214, 216, 218, 220, and 222. As further discussed below, each respective portion of user interface screen 200 may include a suitable indicia, label, text, graphic, icon, etc., to facilitate user interaction with mobile computing device 102.1 and/or to provide the relevant feedback from mobile computing device 102.1 to a user in accordance with the function performed by each respective portion.

In an embodiment, portion 202 may indicate a speed limit for the current road on which the vehicle is traveling and the current road may be displayed in portion 206. The speed limit may be part of the cartographic data that is stored in memory 118. The current calculated speed of the vehicle (e.g., using the geographic location data) may also be displayed in portion 204, and any other suitable data field may be displayed in portion 216 (e.g., compass direction, a time of day, an estimated arrival time, etc.).

In an embodiment, portions 208 and 210 facilitate user interactions with mobile computing device 102.1. For example, a user may select portion 208 to open a menu to adjust settings, options, etc. A user may select portion 210 to exit the current navigation screen 200 and perform other functions provided by the mobile computing device, such as viewing average lane speed and/or heading data, returning to a home screen, entering a new address or waypoint, etc.

In an embodiment, portions 212, 214, and 220 provide navigational information to a user. For example, portion 212 may display a distance and direction of the next turn en route to the user's selected destination, while portion 214 may show information regarding the current road on which the vehicle is travelling. Furthermore, portion 220 may include an actively updating navigational map indicating the position of the vehicle along a designated navigation route, the position of the vehicle along the route, the road lane the vehicle is currently occupying, etc. Portion 220 may include a zoom control button 221, which may be selected by a user to control the zoom level of the map shown in portion 220.

In an embodiment, portion 218 may function as an active lane guidance window, indicating the proper road lane to be followed to stay on the calculated driving route. In accordance with such an embodiment, portion 220 may fill the entire area occupied by both portions 218 and 220 until the vehicle in which mobile computing device 102.1 is mounted approaches a complex intersection, an exit, an interchange, etc., at which time portions 218 and 220 may be displayed as shown in FIGS. 2A-2B. In this way, portion 218 may present detailed information to clarify the navigation of more complex areas in a calculated driving route.

In various embodiments, the average road lane speed for each road lane in a calculated driving route may be displayed to a user in any suitable manner within user interface screen 200. For example, in some embodiments, portion 220 may display the average road lane speed for each road lane having various colors, weights, labels, etc. This embodiment is not shown in FIGS. 2A-2B for purposes of brevity.

To provide another example, in some embodiments, portion 218 may display the average road lane speed for each road lane having various colors, weights, labels, etc. For example, as shown in FIG. 2A, portion 218 includes a highlighted route graphic 230, indicating the direction to take to maintain the current route, and additionally includes average road lane speed indicators 224, 226, and 228. In an embodiment, average road lane speed indicators 224, 226, and 228 (and highlighted route graphic 230) may be displayed having various colors, weights, labels, etc., to indicate the average road lane speed for each road lane.

In an embodiment, the road lane speed indicators may be color-coded. To provide an illustrative example using portion 218 as shown in FIG. 2A, the average road lane speed indicators 224, 226, and 228 (and highlighted route graphic 230) may be displayed as green for average road lane speeds above or equal to some threshold speed V3, yellow for average road lane speeds above a threshold speed V2 and less than V3, and red when below or equal to another threshold speed V1, where V1<V2<V3. Continuing this example, road lane speed indicator 224 may be displayed as green when the corresponding average road lane speed is above V3, road lane speed indicators 226 and 228 may be displayed as yellow when their corresponding average road lane speed (or average group road lane speed) is between V2 and V3, while highlighted route graphic 230 may be displayed as red when its corresponding average road lane speed is below V1. Embodiments in which road lane speed indicators are shown in portion 218 but not in portion 220 may be particularly useful in providing a clean, less cluttered interface, as the road lane speed and/or heading data is shown only when it is likely to be most relevant—when average road lane speeds are more widely varied, such as at intersections, exits, interchanges, etc.

In other embodiments, mobile computing device 102.1 may not display road lane speed indicators at all, but use the average road lane speeds to calculate driving routes and route driving times as background processes.

Regardless of whether the average road lane speed indicators are displayed in any portion of user interface screens 200, user interface screen 200 may display an alert when one of the average road lane speeds is less than or equal to some threshold, which may be V1 or some other threshold speed. For example, as shown in FIG. 2B, portion 250 includes a text notification “slow traffic in left lanes,” which may additionally or alternatively include a voice alert from feedback generator 113. As shown in FIG. 2B, road lane speed indicators 240 and 242 may be appropriately colored (e.g., red) or otherwise displayed to convey this information, while road lane speed indicators 244 and 248 (and highlighted route graphic 246) may be appropriately colored or otherwise displayed to convey their respective average road lane speed (or group road lane speed). In this way, once a driving route is planned, embodiments include mobile computing device 102.1 actively ensuring that a vehicle avoids road lanes with low average speeds, thereby providing navigational guidance at the road lane level.

Additionally or alternatively, the alert may include those previously discussed regarding a lane departure risk and/or a lane blockage warning. For example, if one or more external computing devices 160 archives historical data for average road lane speeds, a mobile computing device (e.g., mobile computing device 102.1) may receive an indication that certain lanes in a route are typically slow based on the present time and day of the week (e.g., during rush hour Monday through Friday certain road lanes may be historically slow).

FIGS. 3A-3C are schematic illustration examples 300 of the timing stages for an exemplary intersection demonstrating how intersection timing may be calculated, according to an embodiment. The intersection shown in FIGS. 3A-3C is a three-way intersection, each road in the intersection having two road lanes. The intersection shown in FIGS. 3A-3C cycles through three subsequent timing stages: timing stage 1 (FIG. 3A), timing stage 2 (FIG. 3B), and timing stage 3 (FIG. 3C). Thus, each of FIGS. 3A-3C demonstrates a different timing stage in the overall repeating cycle of traffic light changes whereby the flow of traffic through the intersection is controlled by traffic light 350.

Although a three way intersection is used in the examples shown in FIGS. 3A-3C, intersections will have a certain number of stages based upon the number of road lanes and the number of intersecting roadways. Therefore, embodiments include expanding the same traffic stage calculations explained with reference to FIGS. 3A-3C for any type of intersection.

Again, embodiments include mobile computing device 102.1 average timing intersection data to improve route calculation quality and improve the accuracy the calculated ETA. In an embodiment, one or more of mobile computing devices 102.1-102.N may transmit its own respective intersection time while in each signal stage as part of the traffic data transmitted to one or more external computing devices 160. One or more external computing devices may store historical intersection timing data using this data, which may be averaged at the road lane level, stored as a range of times at the road-lane level, or stored at some higher level (e.g., averaged over all road lanes, ranges over all road lanes, etc.) if road-level intersection times are not available.

In an embodiment, mobile computing device 102.1 may download and the intersection data from one or more external computing devices 160 and store the intersection timing data in any suitable portion of memory 118. For example, mobile computing device 102.1 may store historical data for intersections as statistical models of the staging of various intersections in a certain geographic radius (e.g., a region serviced by a particular traffic service provider) during short periods over the span of a week. Because the intersection timing data may be indicative of average intersection times on a road-lane level, mobile computing device 102.1 may then utilize the intersection timing data to predict when a particular traffic light for the vehicle's current lane will change and calculate the corresponding time to get through the intersection when in a particular road lane. The various traffic timing stages that may be used in this manner are further discussed below.

FIG. 3A illustrates the flow of traffic associated with stage 1 of three different traffic timing stages associated with the three-way intersection for each of road lanes 302, 304, and 306. In stage 1, traffic light 350 is green for eastbound and westbound road lanes 302 and 306, but red for northbound road lane 304. Therefore, for road lanes 302 and 306, the timing for stage 1 includes traffic light 350 being green for some period of time A, and then yellow for a period of time B. For road lane 304, the timing for stage 1 includes traffic light 350 being red for some period of time C.

FIG. 3B illustrates the flow of traffic associated with stage 2 of three different traffic timing stages associated with the three-way intersection for each of road lanes 302, 304, and 306. In stage 2, traffic light 350 is red for eastbound and westbound road lanes 302 and 306, but green for northbound road lane 304. Therefore, for road lanes 302 and 306, the timing for stage 2 includes traffic light 350 being red for some period of time D. For road lane 304, the timing for stage 2 includes traffic light 350 being green for some period of time E, and then yellow for a period of time F.

FIG. 3C illustrates the flow of traffic associated with stage 3 of three different traffic timing stages associated with the three-way intersection for each of road lanes 302, 304, and 306. In stage 3, traffic light 350 is red for eastbound road lane 302 and northbound road lane 306, while traffic light 350 is green for westbound road lane 302. Therefore, for road lane 302, the timing for stage 3 includes traffic light 350 being green for some period of time G, and then yellow for a period of time H. For road lanes 304 and 306, the timing for stage 3 includes traffic light green 350 being red for some period of time J.

In an embodiment, the mobile computing device may predict when the light will change for the current lane by determining which timing stage of an intersection the vehicle is currently in. In various embodiments, mobile computing device 102.1 may use the current and past signal state, the current lane, the direction of traffic, and historical intersection data to facilitate these calculations.

To provide an illustrative example, if mobile computing device 102.1 is located in a vehicle approaching the intersection shown in FIGS. 3A-3C and traffic light 350 changes to red, resulting in traffic proceeding eastbound in road lane 306, then mobile computing device 102.1 may determine that the intersection is in timing stage 1. Once this is determined, embodiments include mobile computing device 102.1 predicting that traffic light 350 will turn green in no fewer than (A+B) seconds, since stage 2 follows stage 1 (for this example intersection). In some embodiments, A and B may be fixed for standard intersections, represented as a historical range for smart intersections (e.g. those intersections that are triggered by sensors to change on-demand), may be correlated to the time of day, etc. In this way, mobile computing device 102.1 may incorporate the intersection timing data at the road-lane level for a calculated driving route, which may also be calculated at the road lane level, to improve the accuracy in which the route driving time (ETA) is calculated.

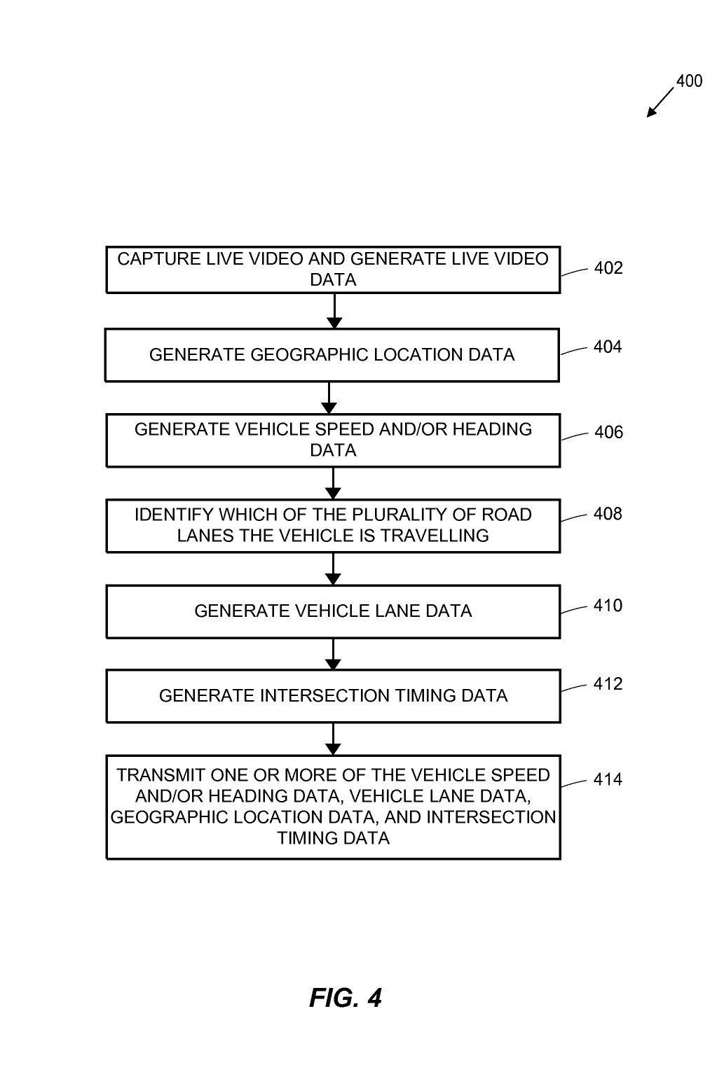

FIG. 4 illustrates a method flow 400, according to an embodiment. In an embodiment, one or more regions of method 400 (or the entire method 400) may be implemented by any suitable device. For example, one or more regions of method 400 may be performed by mobile computing device 102.1, as shown in FIG. 1.

In an embodiment, method 400 may be performed by any suitable combination of one or more processors, applications, algorithms, and/or routines, such as processor 110 executing instructions stored in lane detection module 120, for example, as shown in FIG. 1. Further in accordance with such an embodiment, method 400 may be performed by one or more processors working in conjunction with one or more other components within a mobile computing device, such as processor 110 working in conjunction with one or more of communication unit 104, user interface 106, sensor array 108, display 112, location determining component 114, one or more cameras 116, memory 118, etc.

Method 400 may start when one or more processors 110 capture live video and generate live video data (block 402). In an embodiment, the live video data may include, for example, dash cam video such as a view of a road in front of the vehicle in which mobile computing device 102.1 is mounted (block 402).

Method 400 may include one or more processors 110 generating geographic location data indicative of a geographic location of the mobile computing device 102.1 (block 404). This may include, for example, location determining component 114 and/or processor 110 receiving and processing one or more GNSS signals to generate the geographic location data (block 404).

Method 400 may include one or more processors 110 generating vehicle speed and/or heading data indicative of the speed of the vehicle in which mobile computing device 102.1 is located while travelling in the road lane (block 406). This may include, for example, one or more processors 110 determining a speed of the vehicle based upon changes in the geographic location data over time and encoding this speed value as part of the vehicle speed and/or heading data (block 406).

Method 400 may include one or more processors 110 identifying which of a plurality of road lanes the vehicle is travelling based upon an analysis of the live video data (block 408). Again, this identification may include a left, center, or right lane identification, or a group of lanes such as a left group, a center group, a right group, etc. This determination may be made, for example, by processor 110 analyzing movements of the road lane lines within the live video data (block 408). This may include, for example, one or more processors 110 comparing pixel dimensions among lines identified via a suitable edge detection process, as previously discussed with reference to FIG. 1, to differentiate between solid and dashed road lane lines, and utilizing the differences between solid and dashed lines to ascertain which of the road lanes the vehicle is travelling (block 408).

Method 400 may include one or more processors 110 generating vehicle lane data indicative of the road lane (or road lane group) that the vehicle in which mobile computing device 102.1 is located is travelling (block 410). This may include, for example, one or more processors 110 encoding the vehicle lane identification value or group indicator as part of the vehicle lane data (block 410).

Method 400 may include one or more processors 110 identifying intersection timing data (block 412). In an embodiment, the intersection timing data may be measured by mobile computing device 102 by identifying the geographic location of an intersection from cartographic data and correlating the current geographic location of the vehicle in which mobile computing device 102.1 is located to the geographic location of the intersection. Using a comparison of these locations, mobile computing device 102.1 may determine when the vehicle in which it is located is approaching an intersection (e.g., within a threshold distance, when the vehicle speed slows to below a certain threshold speed, etc.) and begin timing how long the vehicle takes to proceed through the intersection (e.g., after the vehicle is beyond a threshold distance from the intersection, upon the vehicle speed increasing to a certain threshold speed, etc.) (block 412). Method 400 may include one or more processors 110 encoding the measured time value as part of the intersection timing data (block 412).

Method 400 may include one or more processors 110 transmitting one or more of the vehicle speed and/or heading data, the vehicle lane data, the intersection timing data, and/or the geographic location data to one or more external computing devices (e.g., external computing devices 160, as shown in FIG. 1) in accordance with any suitable type of communication protocol as traffic data (block 414). In an embodiment, the geographic location data may identify one or more vehicle locations associated with the vehicle speed and/or heading data, one or more road locations associated with the vehicle road lane data, one or more vehicle locations associated with the intersection timing data, etc., so this data may be identified when received by the one or more external computing devices (block 414).

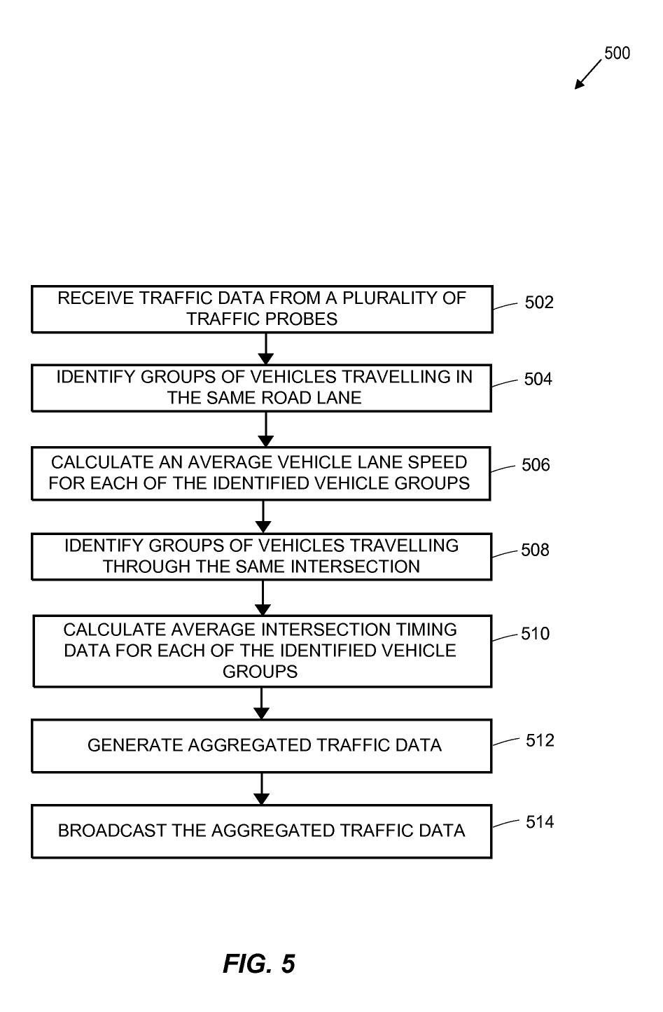

FIG. 5 illustrates a method flow 500, according to an embodiment. In an embodiment, one or more regions of method 500 (or the entire method 500) may be implemented by any suitable device. For example, one or more regions of method 500 may be performed by one or more of external computing devices 160, as shown in FIG. 1. In an embodiment, method 500 may be performed by any suitable combination of one or more processors, applications, algorithms, and/or routines, such as one or more respective processors associated with one or more of external computing devices 160, for example, as shown in FIG. 1. Further in accordance with such an embodiment, method 500 may be performed by one or more of external computing devices 160 functioning as one or more parts of a traffic service provider.

Method 500 may start when one or more external computing devices receive traffic data from a plurality of traffic probes (block 502). In an embodiment, the traffic probes may include, for example, any suitable number of mobile computing devices 102.1-102.N, as shown and previously discussed with reference to FIG. 1 (block 502). In an embodiment, the traffic data may include one or more of the vehicle speed and/or heading data, the vehicle lane data, the intersection timing data, and/or the geographic location data as previously discussed with reference to block 414 of method 400 (block 502).

Method 500 may include one or more external computing devices identifying groups of vehicles travelling in the same road lane (or road lane group) (block 504). This may include, for example, correlating the geographic location data and the vehicle road lane data, received as part of the traffic data, to determine which vehicles are in the same road lane (or road lane group) on the same road and in proximity to one another (e.g., within a certain threshold distance along the same road) (block 504).

Method 500 may include one or more external computing devices calculating an average vehicle road lane speed for each of the identified vehicle groups (block 506). This may include, for example, averaging the speeds indicated by the vehicle speed and/or heading data received as part of the traffic data to determine an average vehicle road lane speed for one or more road lanes in a certain location on a road as indicated by the geographic location data (block 506).

Method 500 may include one or more external computing devices identifying groups of vehicles travelling through the same intersection (block 508). This may include, for example, correlating the geographic location data, received as part of the traffic data, to determine which vehicles are located at the same intersection (e.g., within a certain threshold distance of an intersection location) (block 508). In some embodiments, method 500 may include one or more external computing devices identifying groups of vehicle in the same lane at the same intersection (block 508).

Method 500 may include one or more external computing devices utilizing intersection timing data from each of the identified vehicle groups travelling in the same road lane (block 504) that are also part of the identified vehicle groups travelling through the same intersection (block 508) to calculate average intersection timing data for each road lane (block 510). This may include, for example, averaging the time elapsed for vehicles located in the same road lane to travel through the same intersection and generating sets of intersection timing data for each road lane associated with the same intersection (block 510).

Method 500 may include one or more external computing devices generating aggregated traffic data (block 512). The aggregated traffic data may include, for example, the averaged vehicle lane speed, an identification of each vehicle's corresponding road lane or road lane group, geographic location data corresponding to the geographic location of the road for which the average vehicle lane speed and/or heading data is applicable, the averaged intersection timing data, etc. (block 512). Additionally or alternatively, embodiments include the aggregated traffic data including intersection timing data from other sources, such as databases, etc., received via communications with devices other than traffic probes (block 512).

Method 500 may include one or more external computing devices broadcasting the aggregated traffic data (block 514). This may include, for example, encoding the aggregated traffic data and transmitting the aggregated traffic data in accordance with any suitable type of communication protocol (block 514). In an embodiment, the aggregated traffic data may be received by one or more mobile computing devices 102.1-102.N, as shown in FIG. 1.

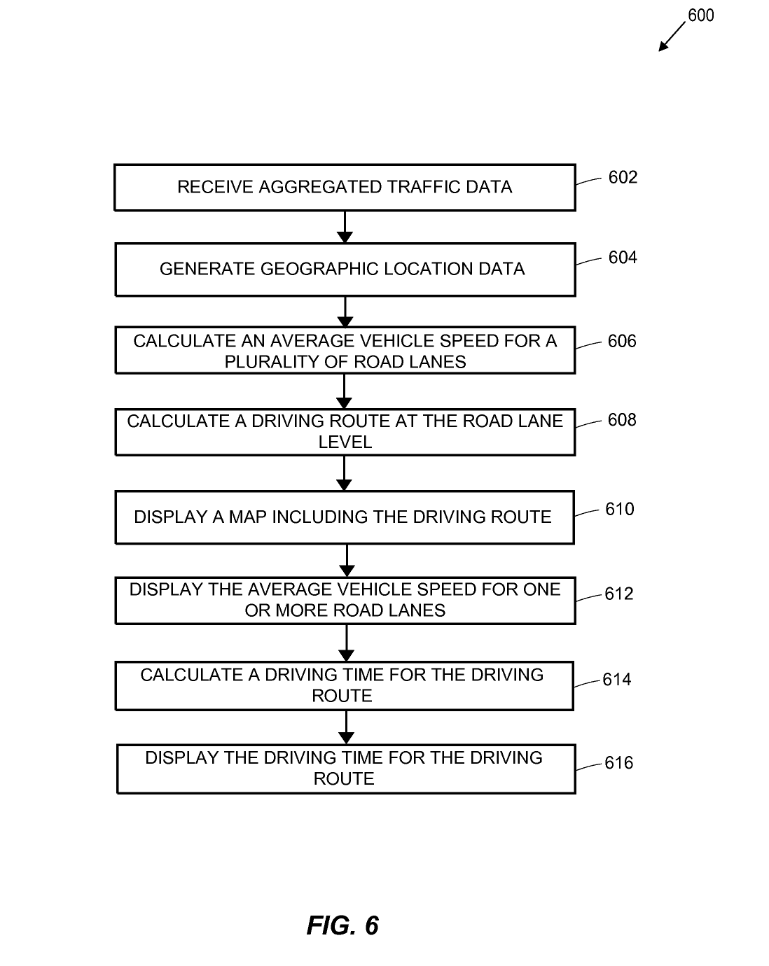

FIG. 6 illustrates a method flow 600, according to an embodiment. In an embodiment, one or more regions of method 600 (or the entire method 600) may be implemented by any suitable device. For example, one or more regions of method 600 may be performed by mobile computing device 102.1, as shown in FIG. 1.

In an embodiment, method 600 may be performed by any suitable combination of one or more processors, applications, algorithms, and/or routines, such as processor 110 executing instructions stored in lane speed calculation module 122 and/or routing calculation module 124, for example, as shown in FIG. 1. Further in accordance with such an embodiment, method 600 may be performed by one or more processors working in conjunction with one or more other components within a mobile computing device, such as processor 110 working in conjunction with one or more of communication unit 104, user interface 106, sensor array 108, display 112, location determining component 114, one or more cameras 116, memory 118, etc.

Method 600 may start when one or more processors 110 receive aggregated traffic data from an external computing device (block 602). The aggregated traffic data may include, for example, the aggregated traffic data broadcasted by the external computing device, as previously discussed with reference to block 514 of method 500 (block 602).

Method 600 may include one or more processors 110 generating geographic location data indicative of a geographic location of the mobile computing device 102.1 (block 604). This may include, for example, location determining component 114 and/or processor 110 receiving and processing one or more GNSS signals to generate the geographic location data (block 604).

Method 600 may include one or more processors 110 calculating an average vehicle speed for each of a plurality of road lanes based upon the aggregated traffic data (block 606). This may include, for example, or more processors 100 decoding the average road lane speed and associating, using the geographic location data included in the aggregated traffic data, the average road lane speed and/or heading data with one or more road lanes for the road on which the vehicle is currently travelling (block 606).

Method 600 may include one or more processors 110 calculating a driving route at the road-lane level (block 608). This may include, for example, one or more processors 110 calculating the driving route by selecting road lanes having the fastest average road lane speed as indicated by the calculated average road lane speed and/or heading data (block 608).

Method 600 may include one or more processors 110 displaying a map including the driving route (block 610). This may include, for example, one or more processors 110 displaying a map including the geographic location of the vehicle and a highlighted active route, as previously discussed with reference to portion 220 of FIGS. 2A-2B (block 610).

Method 600 may include one or more processors 110 displaying a map including the average vehicle speed for one or more road lanes (block 612). This may include, for example, one or more processors 110 displaying a map including active lane guidance and an indication of the average road lane speed for one or more lanes in the calculated route, as previously discussed with reference to portion 218 of FIGS. 2A-2B (block 612).

Method 600 may include one or more processors 110 calculating a driving time (ETA) for the calculated driving route (block 614). This may include, for example, one or more processors 110 calculating a driving time using the average vehicle lane speeds corresponding to the road lanes in the calculated driving route (block 614). In some embodiments, the driving time may additionally take into considerations the intersection timing data for each road lane in the calculated driving route, which may be ascertained, for example, from the aggregated traffic data (block 614).

Method 600 may include one or more processors 110 displaying the driving time for the calculated driving route (block 616). This may include, for example, one or more processors 110 displaying the driving time as an ETA time, as previously discussed with reference to portion 216 of FIGS. 2A-2B (block 616).

Although the foregoing text sets forth a detailed description of numerous different embodiments, it should be understood that the detailed description is to be construed as exemplary only and does not describe every possible embodiment because describing every possible embodiment would be impractical, if not impossible. In light of the foregoing text, numerous alternative embodiments may be implemented, using either current technology or technology developed after the filing date of this patent application.

Having thus described various embodiments of the technology, what is claimed as new and desired to be protected by Letters Patent includes the following:

1. A mobile computing device configured to be mounted within a vehicle, the vehicle being configured to drive in a lane from among a plurality of lanes on a road, the mobile computing device comprising:
a camera configured to capture live video when mounted in or on the vehicle and to generate live video data;
a location determining component configured to generate geographic location data indicative of a geographic location of the vehicle when the mobile computing device is mounted within the vehicle;
a processor configured to perform the following when the navigational device is mounted within the vehicle:
generate vehicle speed data indicative of the speed of the vehicle while the vehicle is travelling in the road lane, the speed of the vehicle being based upon changes in the geographic location data over time,
identify in which of the plurality of road lanes the vehicle is travelling based upon an analysis of the live video data,
generate vehicle lane data indicative of the road lane in which the vehicle is travelling; and
a communication unit configured to transmit the vehicle speed data and the vehicle lane data to an external computing device as traffic data.

2. The mobile computing device of claim 1, wherein the processor is configured to identify the road lane in which the vehicle is travelling as one of a left, center, or right lane.

3. The mobile computing device of claim 1, wherein:
the mobile computing device is one of a plurality of mobile computing devices mounted in a plurality of respective vehicles,
each of the plurality of mobile computing devices is configured to transmit its respective vehicle traffic data to the external computing device, and
the external computing device is configured to:
group the vehicle speed data according to vehicles from among the plurality of vehicles that are travelling in the same road lane to generate lane-grouped vehicle speed data, and
calculate an average vehicle speed for each of the plurality of road lanes by averaging the lane-grouped vehicle speed data.

4. The mobile computing device of claim 3, wherein the communication unit is further configured to receive the average vehicle speed for each of the plurality of road lanes, and further comprising:
a display configured to display the average vehicle speed for each of the plurality of road lanes.

5. The mobile computing device of claim 1, wherein the processor is further configured to identify road lane line markers within the live video data as line segments in accordance with an edge detection process, and to identify in which of the plurality of road lanes the vehicle is travelling based upon the identified line segments.

6. The mobile computing device of claim 5, wherein the processor is further configured to identify the line segments as dashed or solid, and to identify in which of the plurality of road lanes the vehicle is travelling by comparing the positions of dashed and solid lines to one another.

7. A mobile computing device configured to be mounted in a vehicle, the mobile computing device comprising:
a communication unit configured to receive aggregated traffic data from an external computing device,
wherein the aggregated traffic data is indicative of an average vehicle speed for each of a plurality of road lanes on a road, the average vehicle speed for each of the plurality of road lanes being calculated as an average speed of vehicles travelling in the same road lane;
a location-determining component configured to generate geographic location data indicative of a geographic location of the vehicle when the mobile computing device is mounted within the vehicle;
a processor configured to calculate the average vehicle speed for each of the plurality of road lanes based upon the aggregated traffic data; and
a display configured to:
display a map including the geographic location of the vehicle and indicating a driving route, and
display an indication of the average vehicle speed for each of a plurality of road lanes.

8. The mobile computing device of claim 7, wherein:
vehicle lane speed data is transmitted from a plurality of mobile computing devices to the external computing device, each of the plurality of mobile computing devices being mounted in a respective vehicle from among a plurality of vehicles, and
the external computing device (i) receives the vehicle lane speed data transmitted by the plurality of mobile computing devices, (ii) calculates, for each of the plurality of road lanes, an average vehicle lane speed for vehicles travelling in the same road lane, and (iii) transmits the aggregated traffic data to the mobile computing device including the average vehicle lane speed for each of the plurality of road lanes.

9. The mobile computing device of claim 7, wherein the display is further configured to display the average vehicle lane speed for each of the plurality of road lanes.

10. The mobile computing device of claim 9, wherein the processor is further configured to calculate the driving route based upon changes in the geographic location of the vehicle over time and a selected destination, the driving route being calculated at a road-lane level utilizing the average vehicle lane speed for each of the plurality of road lanes.

11. The mobile computing device of claim 10, wherein the processor is further configured to optimize the driving route by selecting road lanes from among the plurality of road lanes within the driving route having the fastest average vehicle lane speeds.

12. The mobile computing device of claim 10, wherein the display is further configured to display the map in a first window including the driving route, and to display the average vehicle lane speed for each of the plurality of road lanes as color-coded information in a second window.

13. The mobile computing device of claim 9, wherein the processor is further configured to issue an alert to avoid road lanes from among the plurality of road lanes that are associated with an average vehicle lane speed that is less than a threshold speed.

14. A mobile computing device configured to be mounted in or on a vehicle, the vehicle being configured to drive in a lane from among a plurality of lanes on a road, the mobile computing device comprising:
a communication device configured to receive, from an external computing device, when the mobile computing device is mounted within the vehicle:
vehicle lane speed data indicative of a vehicle lane speed for each of a plurality of road lanes on a road, the vehicle lane speed for each of the plurality of road lanes being calculated as an average speed of vehicles travelling in the same road lane from among the plurality of road lanes, and
intersection timing data indicative of an average time for a vehicle to proceed through each of a plurality of intersections,
a location-determining component configured to generate geographic location data indicative of a geographic location of the vehicle when the mobile computing device is mounted in the vehicle; and
a processor configured to perform the following when the mobile computing device is mounted in the vehicle:
calculate a road-lane level driving route utilizing the vehicle lane speed data based upon the geographic location of the vehicle and a selected destination,
identify intersections from among the plurality of intersections along the calculated route, and
calculate an estimated time of arrival (ETA) corresponding to the road-lane level driving route based upon the average speed of each of the plurality of road lanes along the road-lane level driving route and the average time for a vehicle to proceed through each of a plurality of intersections along the road-lane level driving route.

15. The mobile computing device of claim 14, wherein vehicle lane speed data is transmitted to the external computing device from a plurality of mobile computing devices, each of the plurality of mobile computing devices being mounted in a respective vehicle from among a plurality of vehicles, and wherein the external computing device utilizes the vehicle lane speed data to generate the aggregated traffic data.

16. The mobile computing device of claim 14, wherein the processor is further configured to optimize the road-lane level driving route by selecting road lanes from among the plurality of road lanes within the road-lane level driving route having the fastest vehicle lane speeds.

17. The mobile computing device of claim 14, wherein the processor is further configured to optimize the road-lane level driving route by selecting intersections from among the plurality of intersections within the road-lane level driving route having the fastest average times.

18. The mobile computing device of claim 14, wherein the intersection timing data includes, for each of the plurality of intersections, a plurality of average times, and
wherein the plurality of average times correspond to respective average times for a vehicle to proceed through each of the plurality of intersections while travelling in each of the plurality of road lanes.

19. The mobile computing device of claim 14, wherein the processor is further configured to issue an alert to avoid road lanes from among the plurality of road lanes that are associated with a vehicle lane speed less than a threshold speed.

20. The navigational device of claim 14, further comprising:
a display configured to display a map of the driving route in a first window, and to display the vehicle lane speed for each of the plurality of road lanes as color-coded information in a second window.
